(19) United States
(12) Patent Application Publication
(10) Pub. No.: US 2008/0219743 A1
(43) Pub. Date: Sep. 11, 2008

(54) TAPE DRIVE

(76) Inventors: Martin McNestry, Derbyshire (GB); Keith Buxton, Nottingham (GB); George Borkey Yundt, Andover, MA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/043,222

(22) Filed: Mar. 6, 2008

Related U.S. Application Data
(60) Provisional application No. 60/894,522, filed on Mar. 13, 2007.

(30) Foreign Application Priority Data
Mar. 7, 2007 (GB) 0704372.2

(51) Int. Cl. B41J 33/02

(52) U.S. Cl. 400/234

(57) ABSTRACT

A tape drive comprising two position-controlled motors, at least one of which is a closed-loop position-controlled motor, two tape spool supports on which spools of tape may be mounted, each spool being drivable by a respective one of said motors, and a controller for controlling the energization of the motors such that the tape may be transported in at least one direction between spools mounted on the spool supports. The controller is operative to energise both motors to drive the spools of tape in the direction of tape transport, to monitor tension in a tape being transported between spools mounted on the spool supports and to control the motors to maintain the monitored tension between predetermined limits.

### CROSS-REFERENCE TO RELATED APPLICATIONS

This application claims priority to and is based on United Kingdom Application No. 0704372.2 filed Mar. 7, 2007, and incorporated herein by reference in its entirety.

In addition, this application claims priority to and is based on U.S. Provisional Application No. 60/894,522 filed Mar. 13, 2007, and incorporated herein by reference in its entirety.

### BACKGROUND OF THE INVENTION

The present invention relates to a tape drive. Such a tape drive may form part of printing apparatus. In particular, such a tape drive may be used in transfer printers, that is, printers which make use of carrier-supported inks.

In transfer printers, a tape which is normally referred to as a printer tape and carries ink on one side is presented within a printer such that a printhead can contact the other side of the tape to cause the ink to be transferred from the tape on to a target substrate of, for example, paper or a flexible film. Such printers are used in many applications. Industrial printing applications include thermal transfer label printers and thermal transfer coders which print directly on to a substrate such as packaging materials manufactured from flexible film or card.

Ink tape is normally delivered to the end user in the form of a roll wound onto a core. The end user pushes the core on to a tape spool, pulls a free end of the roll to release a length of tape, and then engages the end of the tape with a further spool. The spools may be mounted on a cassette, which can be readily mounted on a printing machine. The printing machine includes a transport means for driving the spools, so as to unwind tape from one spool and to take up tape on the other spool. The printing apparatus transports tape between the two spools along a predetermined path past the printhead.

Known printers of the above type rely upon a wide range of different approaches to the problem of how to drive the tape spools. Some rely upon stepper motors operating in a position control mode to pay out or take-up a predetermined quantity of tape. Other known printers rely on DC motors operating in a torque mode to provide tension in the tape and to directly or indirectly drive the spools. Some known arrangements drive only the spool on to which tape is taken up (the take-up spool) and rely upon some form of “slipping clutch” arrangement on the spool from which tape is drawn (the supply spool) to provide a resistive drag force so as to ensure that the tape is maintained in tension during the printing and tape winding processes and to prevent tape overrun when the tape is brought to rest. It will be appreciated that maintaining adequate tension is an essential requirement for the proper functioning of the printer.

Alternative forms of known printer tape drives drive both the take-up spool and the supply spool. A supply spool motor may be arranged to apply a predetermined drag to the tape, by being driven in the reverse direction to the direction of tape transport. In such an arrangement (referred to herein as “pull-drag”), the motor connected to the take-up spool is arranged to apply a greater force to the tape than the motor connected to the supply spool such that the supply spool motor is overpowered and the supply spool thus rotates in the direction of tape transport. The supply spool drag motor keeps the tape tensioned in normal operation.

In a further alternative arrangement a supply spool motor may be driven in the direction of tape transport such that it contributes to driving the tape from the supply spool to the take-up spool. Such an arrangement is referred to herein as “push-pull”. The take-up motor pulls the tape onto the take-up spool as tape is unwound by the supply spool motor such that tape tension is maintained. Such a push-pull arrangement is described in our earlier UK Patent No. GB 2,369,602, which discloses the use of a pair of stepper motors to drive the supply spool and the take-up spool. In GB 2,369,602 a controller is arranged to control the energisation of the motors such that the tape may be transported in both directions between spools of tape. The tension in the tape being transported between spools is monitored and the motors are controlled to energise both motors to drive the spools of tape in the direction of tape transport.

As a printer gradually uses a roll of tape, the outer diameter of the supply spool decreases and the outer diameter of the take-up spool increases. In slipping clutch arrangements, which offer an essentially constant resistive torque, the tape tension will vary in proportion to the diameter of the spools. Given that it is desirable to use large supply spools so as to minimise the number of times that a tape roll has to be replenished, this is a serious problem particularly in high-speed machines where rapid tape transport is essential. For tape drives that use both a take-up motor and a supply spool motor, the variation in spool diameters can make it difficult to determine the correct drive signal to be supplied to each motor such that tape tension is maintained, and/or that tape is unwound or rewound at the correct rate.

Given these constraints, known printer designs offer a compromise in performance by way of limiting the rate of acceleration, the rate of deceleration, and the maximum speed capability of the tape transport system. Overall printer performance has, as a result, been compromised in some cases.

Known tape drive systems generally operate in one of two manners, that is either continuous printing or intermittent printing. In both modes of operation, the apparatus performs a regularly repeated series of printing cycles, each cycle including a printing phase during which ink is being transferred to a substrate, and a further non-printing phase during which the apparatus is prepared for the printing phase of the next cycle.

In continuous printing, during the printing phase a stationary printhead is brought into contact with a printer tape the other side of which is in contact with a substrate on to which an image is to be printed. The term “stationary” is used in the context of continuous printing to indicate that although the printhead will be moved into and out of contact with the tape, it will not move relative to the tape path in the direction in which tape is advanced along that path. During printing, both the substrate and tape are transported past the printhead, generally but not necessarily at the same speed.

Generally only relatively small lengths of the substrate which is transported past the printhead are to be printed upon, and therefore to avoid gross wastage of tape it is necessary to reverse the direction of travel of the tape between printing operations. Thus in a typical printing process in which the substrate is travelling at a constant velocity, the printhead is extended into contact with the tape only when the printhead is adjacent to regions of the substrate to be printed. Immediately before extension of the printhead, the tape must be accelerated up to, for example, the speed of travel of the substrate. The tape speed must then be maintained at the constant speed of the substrate during the printing phase and, after the printing phase has been completed, the tape must be decelerated and then driven in the reverse direction so that the used region of the tape is on the upstream side of the printhead.

As the next region of the substrate to be printed approaches, the tape must then be accelerated back up to the normal printing speed and the tape must be positioned so that an unused portion of the tape close to the previously used region of the tape is located between the printhead and the substrate when the printhead is advanced to the printing position. Thus very rapid acceleration and deceleration of the tape in both directions is required, and the tape drive system must be capable of accurately locating the tape so as to avoid a printing operation being conducted when a previously used portion of the tape is interposed between the printhead and the substrate.

In intermittent printing, a substrate is advanced past a printhead in a stepwise manner such that during the printing phase of each cycle the substrate and generally but not necessarily the tape, are stationary. Relative movement between the substrate, tape and printhead are achieved by displacing the printhead relative to the substrate and tape. Between the printing phase of successive cycles, the substrate is advanced so as to present the next region to be printed beneath the printhead, and the tape is advanced so that an unused section of tape is located between the printhead and the substrate. Once again rapid and accurate transport of the tape is necessary to ensure that unused tape is always located between the substrate and printhead at a time that the printhead is advanced to conduct a printing operation.

The requirements of high speed transfer printers in terms of tape acceleration, deceleration, speed and positional accuracy are such that many known drive mechanisms have difficulty delivering acceptable performance with a high degree of reliability. Similar constraints also apply in applications other than high-speed printers, for instance drives used in labelling machines, which are adapted to apply labels detached from a label web. Tape drives in accordance with embodiments of the present invention are suitable for use in labelling machines in which labels are detached from a continuous label web which is transported between a supply spool and a take-up spool.

### BRIEF DESCRIPTION OF THE INVENTION

It is an object of embodiments of the present invention to obviate or mitigate one or more of the problems associated with the prior art, whether identified herein or elsewhere. It is a further object of embodiments of the present invention to provide a tape drive which can be used to deliver printer tape in a manner which is capable of meeting the requirements of high speed production lines, although the tape drive of the present invention may of course be used in any other application where similar high performance requirements are demanded.

According to the present invention, there is provided a tape drive comprising two position-controlled motors, at least one of which is a closed-loop position-controlled motor, two tape spool supports on which spools of tape may be mounted, each spool being drivable by a respective one of said motors, and a controller for controlling the energization of the motors such that the tape may be transported in at least one direction between spools mounted on the spool supports, wherein the controller is operative to energise both motors to drive the spools of tape in the direction of tape transport, to monitor tension in a tape being transported between spools mounted on the spool supports and to control the motors to maintain the monitored tension between predetermined limits.

The controller may be arranged to control the motors to transport tape in both directions between the spools. One of the motors may be a stepper motor provided with position detection means. Means may be provided to monitor the power supplied to at least one of the motors and to monitor tape tension based upon the monitored power.

One of the motors may be a torque-controlled motor provided with a position detection means. Means may be provided to monitor the current provided to at least one of the motors, and to monitor tape tension based upon the monitored current. Monitoring of tape tension may be further based upon a measured acceleration of at least one of the motors. Monitoring of tape tension may be further based upon a moment of inertia of at least one of the spools of tape.

It is preferred that each spool support is coupled to a respective motor by means of a drive coupling providing at least one fixed transmission ratio. Preferably, the ratio of angular velocities of each motor and its respective spool support is fixed. Such an arrangement requires that control of a motor to cause a desired linear tape movement from or to a respective spool takes into account the circumference of that spool.

The drive coupling may comprise a drive belt. Alternatively, as each spool support has a respective first axis of rotation and each motor has a shaft with a respective second axis of rotation, the respective first and second axes may be coaxial. Respective drive couplings may interconnect a respective spool shaft to a respective motor shaft.

The tape drive may further comprise means for generating a fault-indicating output if monitored tension falls below a predetermined lower limit. The tape drive may further comprise means for determining diameters of spools of tape mounted on the spool supports.

A tape drive in accordance with embodiments of the present invention relies upon both the motors that drive the two tape spools to drive the tape during tape transport. Thus the two motors operate in push-pull mode. This makes it possible to achieve very high rates of acceleration and deceleration. Tension in the tape being transported is determined by control of the drive motors and therefore is not dependent upon any components that have to contact the tape between the take-up and supply spools. Thus a very simple overall mechanical assembly can be achieved. Given that both motors contribute to tape transport, relatively small and therefore inexpensive and compact motors can be used.

The actual rotational direction of each spool will depend on the sense in which the tape is wound on each spool. If both spools are wound in the same sense then both spools will rotate in the same rotational direction to transport the tape. If the spools are wound in the opposite sense to one another, then the spools will rotate in opposite rotational directions to transport the tape. In any configuration, both spools rotate in the direction of tape transport. However, according to the operating mode of the supply spool motor, the direction in which it is driven may also be in the same direction as the supply spool (when the motor is assisting in driving the tape, by pushing the tape off the spool) or the supply spool motor may be driven in the opposite direction to that of the supply spool (when the motor is providing drag to the tape in order to tension the tape).

The tape drive may be incorporated in a transfer printer for transferring ink from a printer tape to a substrate, which is transported along a predetermined path adjacent to the printer. The tape drive may act as a printer tape drive mechanism for transporting ink ribbon between first and second tape spools, and the printer further comprising a printhead arranged to contact one side of the ribbon to press an opposite side of the ribbon into contact with a substrate on the predetermined path. There may also be provided a printhead drive mechanism for transporting the printhead along a track extending generally parallel to the predetermined substrate transport path (when the printer is operating in an intermittent printing mode) and for displacing the printhead into and out of contact with the tape. A controller may control the printer ink ribbon and printhead drive mechanisms, the controller being selectively programmable either to cause the ink ribbon to be transported relative to the predetermined substrate transport path with the printhead stationary and displaced into contact with the ink ribbon during printing, or to cause the printhead to be transported relative to the ink ribbon and the predetermined substrate transport path and to be displaced into contact with the ink ribbon during printing.

The drive mechanism may be bi-directional such that tape may be transported from a first spool to a second spool and from the second spool to the first. Typically, unused tape is provided in a roll of tape mounted on the supply spool. Used tape is taken up on a roll mounted on the take-up spool. However, as described above, in order to prevent gross ribbon wastage, after a printing operation the tape can be reversed such that unused portions of the tape may be used before being wound onto the take-up spool.

### BRIEF DESCRIPTION OF THE DRAWINGS

Embodiments of the present invention will now be described, by way of example, with reference to the accompanying drawings in which:

FIG. 1 is a schematic illustration of a printer tape drive system in accordance with an embodiment of the present invention; and

FIG. 2 is a schematic illustration of a motor control circuit suitable for use in the tape drive of FIG. 1.

### DETAILED DESCRIPTION OF THE INVENTION

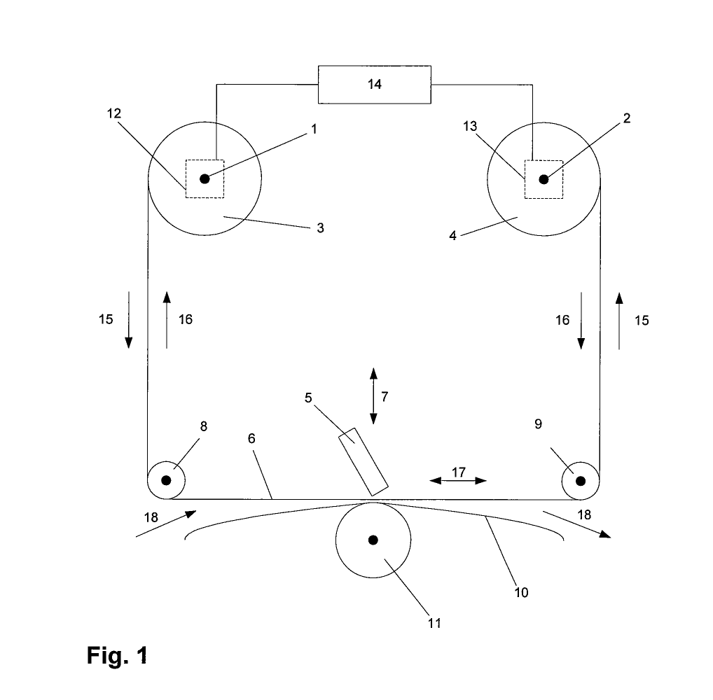

Referring to FIG. 1, this schematically illustrates a tape drive in accordance with the present invention suitable for use in a thermal transfer printer. First and second shafts 1, 2 support a supply spool 3 and a take-up spool 4 respectively. The supply spool 3 is initially wound with a roll of unused tape, and the take-up spool 4 initially does not carry any tape. As tape is used, used portions of the tape are transported from the supply spool 3 to the take-up spool 4. A displaceable printhead 5 is provided, displaceable relative to tape 6 in at least a first direction indicated by arrow 7. Tape 6 extends from the supply spool 3 around rollers 8, 9 to the take-up spool 4. The path followed by the tape 6 between the rollers 8 and 9 passes in front of the printhead 5. A substrate 10 upon which print is to be deposited is brought into contact with the tape 6 between rollers 8 and 9, the tape 6 being interposed between the printhead 5 and the substrate 10. The substrate 10 may be brought into contact with the tape 6 against a platen roller 11.

The supply shaft 1 is driven by a supply motor 12 and the take-up shaft 2 is driven by a take-up motor 13. The supply and take-up motors 12, 13 are illustrated in dashed outline, indicating that they are positioned behind the supply and take-up spools 3, 4. It will however be appreciated that in alternative embodiments of the invention, the spools are not directly driven by the motors. Instead the motor shafts may be operably connected to the respective spools by a belt drive or other similar drive mechanism. In either case, it can be seen that there is a fixed transmission ratio between a motor and its respective spool support.

A controller 14 controls the operation of motors 12, 13 as described in greater detail below. The supply and take-up motors 12, 13 are capable of driving the tape 6 in both directions. Tape movement may be defined as being in the print direction if the tape is moving from the supply spool 3 to the take-up spool 4, as indicated by arrows 15. When tape is moving from the take-up spool 4 to the supply spool 3, the tape may be considered to be moving in the tape reverse direction, as indicated by arrows 16.

When the printer is operating in continuous mode the printhead 5 will be moved into contact with the tape 6 when the tape 6 is moving in the print direction 15. Ink is transferred from the tape 6 to the substrate 10 by the action of the printhead 5. Tape movement may be reversed such that unused portions of the tape 6 are positioned adjacent to the printhead 5 before a subsequent printing operation is commenced.

In the configuration illustrated in FIG. 1, the spools 3, 4 are wound in the same sense as one another and thus rotate in the same rotational direction to transport the tape. Alternatively, the spools 3, 4 may be wound in the opposite sense to one another, and thus must rotate in opposite directions to transport the tape.

As described above, the printer schematically illustrated in FIG. 1 can be used for both continuous and intermittent printing applications. The controller 14 is selectively programmable to select either continuous or intermittent operation. In continuous applications, the substrate 10 will be moving continuously. During a printing cycle, the printhead 5 will be stationary but the tape will move so as to present fresh tape to the printhead 5 as the cycle progresses. In contrast, in intermittent applications, the substrate 10 is stationary during each printing cycle, the necessary relative movement between the substrate 10 and the printhead 5 being achieved by moving the printhead 5 parallel to the tape 6 and substrate 10 in the direction of arrow 17 during the printing cycle. In such a case, the roller 11 is replaced with a flat print platen (not shown) against which the printhead 5 presses the ribbon 6 and substrate 10. In both applications, it is necessary to be able to rapidly advance and return the tape 6 between printing cycles so as to present fresh tape to the printhead and to minimise tape wastage. Given the speed at which printing machines operate, and that fresh tape 6 should be present between the printhead 5 and substrate 10 during every printing cycle, it is necessary to be able to accelerate the tape 6 in both directions at a high rate and to accurately position the tape relative to the printhead. In the arrangement shown in FIG. 1 it is assumed that the substrate 10 will move only to the right as indicated by arrows 18. However, the apparatus can be readily adapted to print on a substrate travelling to the left (that is, in the opposite direction) in FIG. 1.

The driving of tape between the supply spool 3 and the take-up spool 4 is now described in further detail. In embodiments of the invention, both the supply motor 12 and the take-up motor 13 are position-controlled motors.

A position-controlled motor is a motor controlled by a demanded output position. That is, the output position may be varied on demand, or the output rotational velocity may be varied by control of the speed at which the demanded output rotary position changes.

An example of a position-controlled motor is a stepper motor. A stepper motor is an example of an open loop position-controlled motor. That is, it is supplied with an input signal relating to a demanded rotational position or rotational velocity, the stepper motor being driven to achieve the demanded position or velocity. A stepper motor may also be provided with an encoder providing a feedback signal indicative of the actual output position or velocity. The feedback signal may be used to generate an error signal by comparison with the demanded output rotary position, the error signal being used to drive the motor to minimise the error. A stepper motor provided with an encoder in this manner comprises a closed loop form of position-controlled motor.

An alternative form of closed loop position-controlled motor comprises a torque-controlled motor (e.g. a DC motor) provided with an encoder. A torque-controlled motor is a motor that is controlled by a demanded output torque. The output from the encoder provides a feedback signal from which an error signal can be generated when the feedback signal is compared to a demanded output rotary position, the error signal being used to drive the motor to minimise the error.

In the present context the term “DC motor” is to be interpreted broadly as including any form of motor that can be driven to provide an output torque, such as a brushless DC motor, a brushed DC motor, an induction motor or an AC motor. A brushless DC motor comprises any form of electronically commutated motor with integral commutation sensor. Similarly, the term stepper motor is to be interpreted broadly as including any form of motor that can be driven by a signal indicating a required change of rotary position.

An encoder is any form of angular position sensing device, such as an optical encoder, magnetic encoder, resolver, capacitive encoder or any other form of position sensing device. An encoder may be connected to an output shaft of a motor and used to provide a feedback signal indicating the angular position or motion of the motor output shaft.

Tape is driven between the supply spool 3 and the take-up spool 4 by controlling the motors so as to maintain tension in the tape. In general terms tension in tape travelling between the supply spool 3 and the take-up spool 4 is monitored and the supply motor 12 and the take-up motor 13 are controlled by the controller 14 so as to maintain tape tension between predetermined limits. Tape tension may be monitored in a number of ways as is described below. Monitored tension is used as an input to a control algorithm so as to control the motors to maintain tension between predetermined limits, as is now described.

If the monitored tension is too high (above a predetermined limit), then an adjustment can be made to either or both of the position-controlled motors to add a short section of ribbon to the length of ribbon between the spools. If the monitored tension is too low (below a different predetermined limit), then a short section of ribbon can be removed from the length of ribbon between the spools. The control algorithms used to determine the correction amounts of tape added to or removed from the length of tape between the spools may be of conventional form, for example the algorithms known as proportional integral derivative control algorithms (PID control). The algorithms make it possible to compare the monitored tension with predetermined upper and lower limits (the so-called deadband) and, if the monitored tension is outside these limits, the difference between the monitored tension and a “nominal demand” tension which is set at a level between the upper and lower limits may be calculated, the result of that calculation being regarded as an error “signal”. This error “signal” is then mathematically processed through the PID algorithms, which include a proportional gain constant, as well as integral and derivative factors. The mathematical processing results in a “correction” amount of ribbon that needs to be added to or removed from the ribbon path between the spools during the next ribbon feed. This addition or removal of ribbon maintains ribbon tension within acceptable limits.

In greater detail, the correction value may be calculated by calculating the error (the difference between the nominal tension and the monitored tension) and dividing the error by a gain factor which depends upon the ribbon width. The greater the gain factor the tighter the system will be as the nominal tension will be increased. The gain factor is also dependent upon the ribbon width as the gain constants are changed to take account of different ribbon widths. This is because a tension which might cause considerable stretch in a narrow ribbon would cause minimal stretch in a wide ribbon and therefore the effects of adding or removing ribbon from the length of ribbon between the spools is radically affected by ribbon stiffness. Successive cycles may adjust the gain factor from a value nominally of 100 (tight) to a value of nominally 80 (slack). For every consecutive tight or slack reading after a first reading, an extra 0.1 mm correction can be added. An error accumulator is also maintained, and if the accumulated corrections (which are negative for tight and positive for slack) exceed plus or minus 2 mm then an additional 0.1 mm is added to the correction. These are the two integral components which enable the system to operate in a stable manner and maintain ribbon tension at or close to the nominal tension.

The motor feed system splits the correction evenly between both motors in order to avoid large gaps between prints or over-printing on the ribbon. The system does this by calculating the rotary movement that half the correction amounts to for the motor with the largest reel diameter. This movement is calculated with reference to the resolution of the motor driving the spool of largest diameter. The rotary movement is then re-calculated as a distance (relying upon the known spool diameters) and subtracted from the original correction amount. The resultant value is then used to calculate the correction for the motor driving the smaller diameter spool. Because the motor driving the smaller diameter spool has a finer resolution in terms of correction at the edge of the spool it can most accurately feed the remaining distance. Thus the mechanism adjusts the tension by an amount that is as near as possible to that demanded by the original correction.

It has been described above that a mechanism is required to know the diameters of the spools of tape. Various mechanisms can be employed. For example. One known method of monitoring the diameter of a spool of tape is based upon optical sensing comprising at least one emitter and detector pair. The emitter and detector pair is arranged such that as the diameter of the spool changes, the spool blocks that signal from the emitter to the detector, which may be detected. Such an optical spool diameter monitoring technique is disclosed in our earlier UK Patent No. GB 2,369,602.

An alternative method for determining tape spool diameter is disclosed in GB 2,298,821. Here, tape is passed around an idler roller of known diameter. The idler roller is provided with an anti-slip coating to prevent slippage occurring between the tape and the idler roller when the tape is moved. The outer diameter of the idler roller is known. Rotation of the idler roller is monitored. This is achieved by providing the idler roller with a magnetic disc having a north and south pole. Rotation of the idler roller can then be detected by an appropriate magnetic sensor. By detecting rotation of the idler roller of known diameter and knowing a number of steps through which a stepper motor has turned the diameter of a spool of tape associated with the stepper motor can be determined.

Methods for monitoring tension in the tape between the supply spool 3 and the take-up spool 4 are now described. These methods include directly monitoring the tension through the use of a component that contacts the tape and indirect tension monitoring. Direct tension monitoring includes, for example, a resiliently biased roller or dancing arm that is in contact with the tape, arranged such that a change in tape tension causes the roller or dancing arm to move position, the change in position being detectable using, for example a linear displacement sensor. Alternatively, tape may be passed around a roller which bears against a load cell. Tension in the tape affects the force applied to the load cell, such that the output of the load cell provides an indication of tape tension. In these cases the monitored tension is processed by the controller 14 to provide appropriate control the supply motor 12 and the take up motor 13.

If the supply motor 12 and the take-up motor 13 are both torque-controlled motors provided with encoders, tension can be monitored as follows. For one of the supply motor 12 and the take-up motor 13 the motor's angular velocity is measured using the provided encoder. Angular velocity is measured when the motor is moving with constant velocity.

By measuring motor current the motor torque can be calculated. For example, with DC brush motors the motor's torque constant would be known and the torque of the motor can therefore be calculated according to equation (1):

T=KₜI (1)

where:

T is torque;

Kᵣ is the motor torque constant; and

I is the measured current.

It is known that:

P=Tω (2)

where:

P is power; and

ω is angular velocity.

Power values for both the supply motor 12 and take-up motor 13 can be calculated using equation (2). The tension in the tape is then proportional to the ratio of the deduced power values.

It is to be noted that the torque constants of the motors will generally vary with temperature. However, given that the ratio of deduced power values is taken, variations in temperature will be substantially cancelled out, because both motors will be at approximately the same temperature. This is because the motors are in close proximity and attached to a common base plate.

As an alternative, a measure of power may be obtained by reading a current passing through or a voltage across a resistor in series with the power supply to drive electronics associated with each of the motors. The ratio of power supplied to the motors can be used as a measure of the tape tension. This process is now described in further detail, together with an appropriate calibration process.

Initially the take-up motor 12 is energised to remove any slack from the length of ribbon extending between the two spools. An initial estimate of the diameters of the spools is then obtained. This initial estimate can be obtained in any convenient way. For example, an optical system such as that described in our earlier UK Patent No. GB 2,369,602 can be used.

The supply motor 12 is then energised in order to tension the ribbon extending around the supply spool 3. The take up motor 13 is then driven so as to draw ribbon from the supply spool 3, the supply spool motor 12 being deenergized. The rotational movement taken by the motor driving the take-up spool 4 is monitored. The other motor is not stopped, but generates a back-emf resulting in the generation of pulses that are counted. After a few turns of the spools the rotational movement of the take-up motor 13 and the number of pulses generated by the supply motor 12 are counted and the counted numbers are used to establish the ratio between the two diameters. The tape is then brought to a controlled halt. Both motors are decelerated in a controlled manner to avoid overrun. Thus the supply spool motor 12 is driven by pulses to cause deceleration. The application of deceleration pulses to the supply spool motor 12 in synchronism with motor rotation is achieved by monitoring the back-emf generated in that motor, and then energising the motor at an appropriate time to apply a decelerating torque. A number of rotations of the take up spool 4 are required to minimise the chance of any tails of ribbon extending from the spools obstructing optical paths of a scanning arrangement used to determine initial spool diameters, the arrangement being as described in our earlier UK Patent referred to above.

A further optical scan is then performed in both directions to determine the radius of the take up spool 4 whilst that spool is stationary. An optical scan is then repeated as the spool is rotated in 30⁰ increments around the motor shaft by turning the motor through an appropriate rotational movement, that appropriate movement being a constant. This builds up a map of the dimensions of the spool (which may not be perfectly circular) and this map is used to calculate the average radius for each spool for the arc that each will rotate in each ribbon feed and further use these radii to calculate variations in diameter around the spool axes. This makes it possible to accurately determine the circumference of each spool and the effect of a predetermined rotational movement of the motor driving that spool. For example the different calculated radii can be used to calculate the rotational movement required by each motor to drive the spools in an appropriate manner so as to feed the ribbon a predetermined distance. These radii and rotational movements may then be used in tension monitoring calculations such as those described below.

The same optical scan procedure is then performed in both directions to measure the radius of the supply spool 3. This information is then combined with the previously calculated ratio of spool diameters to give an accurate set of data related to the spool diameters and shapes. Tape fed from the supply spool 3 to the take up spool 4 is then rewound back on to the supply spool 3 so as to avoid ribbon wastage.

Stepper motors generally comprise two quadrature-wound coils and current is supplied in a sequence of pulses to one or both of the coils and in both senses (positive and negative) so as to achieve step advance of the motor shafts. In order to achieve a reasonable performance despite the inherent electrical time constant of these coils it is well known to over-drive stepper motors by applying a voltage that is much larger than the nominal rating of the motor and to pulse width modulate this voltage when the desired motor current is reached. For example, with a 3.6 volt motor capable of taking say 2 amps, a voltage of 36 volts may be applied. This results in a very rapid rise in current through the motor, typically in a few tens of micro seconds. Given such overdriving of the supply voltage, relatively short periods of supply voltage application are separated by relatively long periods during which no supply voltage is applied. As a result current from the supply to the motors is very far from smooth. In addition, even when a motor is operating with zero load relating to the function that it performs (equating to zero tension in the printer ribbon), the supply current to the motor will be a function of various factors such as the speed of rotation of the motor, the particular characteristics of that motor (efficiency etc.), and the particular characteristics of the motor drive circuitry (gain and offset variances). It is necessary therefore to calibrate the motors to take account of current variation related to these factors rather than motor load.

Where DC motors are used, it is known to overdrive such motors momentarily e.g. with a 3.6V DC motor capable of taking say 6 amps, a voltage of 36V may be applied.

The motors are calibrated by driving each of them in zero-load conditions at each of a series of different speeds. This will generally cover the range of tape transport speeds required for tape advancement, that range generally being from 100 mm per second to 1000 mm per second tape transport speed. This process is repeated a number of times, for example twenty times, and the average result is used to calculate a motor calibration factor x for each speed, and for each motor. The following relationship is used:

x=N/V

where:

x is the calibration factor for the motor at the given speed;

V is the average measured motor operation value at the given speed; and

N is a constant normalisation or scaling factor.

From the above for each motor a series of values x is calculated for each of the predetermined speeds. When the apparatus is in use, for a given speed one of the values x is selected for use in the calculation of ribbon tension, or a value for x is calculated for the given speed by interpolation from the two values of x for the predetermined speed closest to the given speed.

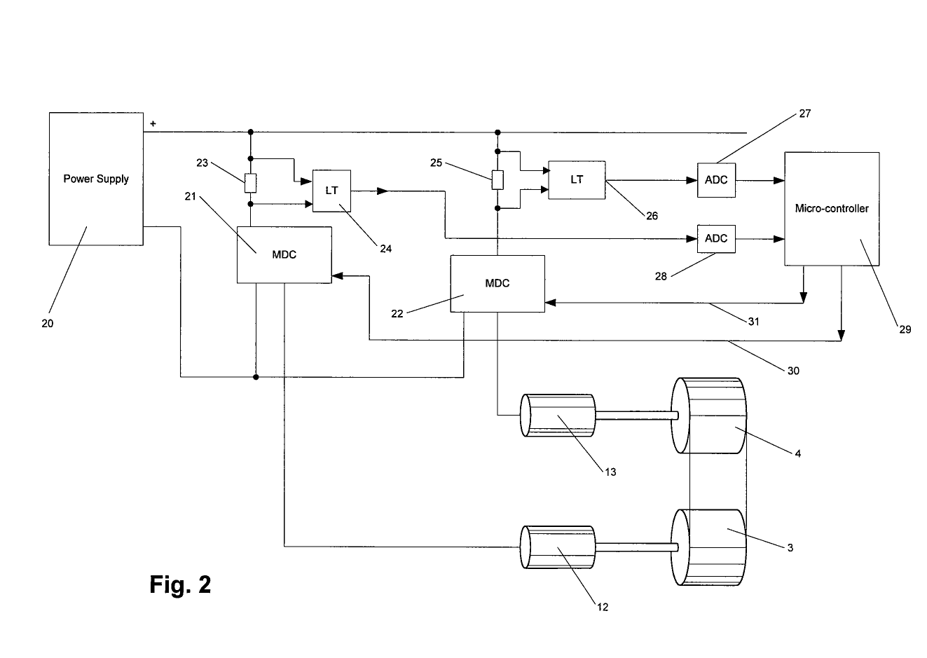

FIG. 2 illustrates the calculation of the values V both during motor calibration and in subsequent ribbon tension control. Referring to FIG. 2, a regulated power supply 20 energises a first motor drive circuit 21 and a second motor drive circuit 22. Current from the supply 20 to the motor drive circuit 21 is delivered through a low resistance resistor 23, the potential developed across the resistor 23 being applied to a level translator 24. Similarly, current to the motor drive 22 is delivered through a low resistance value resistor 25 and the voltage developed across that resistor is applied to a level translator 26. The outputs of the level translators 24 and 26 are applied to analogue to digital converters 27 and 28 the outputs of which are applied to a micro controller 29. The micro controller delivers an output 30 to the first motor drive 21 and an output 31 to the second motor drive 22. The motor drives energise the supply motor 12 driving the supply spool 3 and the take-up motor 13 driving the take-up spool 4.

During motor calibration, no spools are mounted on the outputs of the motors 12, 13. For a given speed for each motor the outputs of the ADC's 27 and 28 are recorded such that x and V for each motor at each of the preselected speeds is known. Those values are then used as described below to enable direct monitoring of ribbon tension in the ribbon between the spools 3 and 4, these spools having been mounted on the output shafts of the stepper motors 12 and 13.

The formulas used for tension calculation are as follows, assuming that motor 13 is pulling and motor 12 is pushing:

V₁x₁=(N+r₁tx₁)f(Temp) (3)

V₂x₂=(N−r₂tx₂)f(Temp) (4)

where:

V₁ is the output of ADC 28 given a selected constant step-rate ribbon feed;

V₂ is the output of ADC 27 during ribbon feed;

r₁ is the radius of the spool 34;

r₂ is the radius of the spool 35;

x₁ is the calibration factor for motor 32 for the selected constant speed;

x₂ is the calibration factor for motor 33 for the speed of motor 33;

N is the scaling factor used during motor calibration;

t is the ribbon tension; and

f(Temp) is a temperature-related function.

Temperature variations which will affect the measured values V₁ and V₂ will generally affect both motors to a similar extent. Therefore by dividing equation (3) by equation (4) the functions f(Temp) will cancel out. The equation can therefore be resolved to derive a measure of tension t as follows:

t=N((V₁/x₂)−(V₂/x₁))/(V₂r₁+V₁r₂) (5)

Thus for any given speed for the motors, the appropriate calibration factors x₁, x₂ can be looked up and used to derive a measure of the ribbon tension t.

In alternative embodiments of the invention, equations (3), (4) and (5) may be modified to take account of motor speed, or where stepper motors are used, to take account of step rate.

In an alternative embodiment of the invention, tension is monitored using an alternative method. At rest or when the tape is travelling at a constant velocity, the spools may be held by a known current. Given that for a torque-controlled motor of the type described above current is proportionally related to torque by the motor's torque constant, the torque provided by each motor can be determined.

Tension can then be calculated by dividing the torque value by the radius of each spool. Given that each value should ideally be equal, the obtained values can be averaged to improve accuracy.

Alternatively, the acceleration or deceleration of each spool can be measured using the encoders.

It is known that:

A=Kₜ/J (6)

where:

A is the acceleration per unit of current;

Kₜ is the torque constant of the motor; and

J is the moment of inertia of the spool of tape.

### Therefore:

A′=A/I_{J} (7)

where:

A′ is the measured acceleration; and

I_{J} is the current producing that acceleration.

It can be seen that:

Iₘ=I_{J}+I_{T} (8)

where:

Iₘ is the current provided to the motor; and

I_{T} is the current providing tension in the tape.

From equations (6), (7) and (8) it can be deduced that:

Iₘ−A′/(Kₜ/J)=I_{T} (9)

Given that Iₘ and A′ can be measured, and given that Kₜ and J are known, the tension in the tape can be calculated. Specifically, the tension in the tape can be calculated using equation (10):

t=(I_{T}K_{T})/R (10)

where:

t is tape tension; and

R is spool radius.

It will be appreciated that if a particularly low tension reading is calculated by any of the above methods, this can be taken by the control system as indicating a fault condition, for example ribbon breakage, or the ribbon becoming so slack that the system is most unlikely to be able to effect adequate control. In such circumstances, the control system can output a “broken ribbon” predetermined low limits, such that when the measured tension falls below this limit, the control system can halt the printing process and assert appropriate fault outputs and warning messages. Thus the system can offer valuable “broken ribbon” detection without the need for additional sensing arrangements.

In the preceding description it has been explained that both the supply motor 12 and the take-up motor 13 are controlled to maintain tension in the tape between predetermined limits. It has further been explained that when a length of tape is added to or subtracted from the tape extending between the spools, this is achieved by controlling both the motors. It will be appreciated that in alternative embodiments of the invention the necessary correction can be achieved using only one of the supply motor 12 and the take-up motor 13.

Further modifications and applications of the present invention will be readily apparent to the appropriately skilled person from the teaching herein, without departing from the scope of the appended claims.

What is claimed is:

1. A tape drive comprising two position-controlled motors, at least one of which is a closed-loop position-controlled motor, two tape spool supports on which spools of tape may be mounted, each spool being drivable by a respective one of said motors, and a controller for controlling the energization of the motors such that the tape may be transported in at least one direction between spools mounted on the spool supports, wherein the controller is operative to energise both motors to drive the spools of tape in the direction of tape transport, to monitor tension in a tape being transported between spools mounted on the spool supports and to control the motors to maintain the monitored tension between predetermined limits.

2. A tape drive according to claim 1, wherein the controller is arranged to control the motors to transport tape in both directions between the spools.

3. A tape drive according to claim 1, wherein one of the motors is stepper motors provided with position detection means.

4. A tape drive according to claim 1, wherein means are provided to monitor the power supplied to at least one of the motors and to monitor tape tension based upon the monitored power.

6. A tape drive according to claim 1, wherein in one of the motors is a torque-controlled motor provided with an encoder.

7. A tape drive according to claim 1, wherein means are provided to monitor the current provided to at least one of the motors, and to monitor tape tension based upon the monitored current.

8. A tape drive according to claim 7, wherein monitoring of tape tension is further based upon a measured acceleration of at least one of the motors.

9. A tape drive according to claim 7, wherein monitoring of tape tension is further based upon a moment of inertia of at least one of the spools of tape.

10. A tape drive according to claim 1, further comprising means for generating a fault-indicating output if monitored tension falls below a predetermined lower limit.

11. A tape drive according to claim 1, wherein each spool support is coupled to a respective motor by means of a drive coupling providing at least one fixed transmission ratio.

12. A tape drive according to claim 11, wherein the drive coupling comprises a drive belt.

13. A tape drive according to claim 1, wherein each spool support has a respective first axis of rotation, each motor has a shaft with a respective second axis of rotation, and the respective first and second axes are co axial.

14. A tape drive according to claim 1, wherein each spool support has a respective spool shaft, each motor has a respective motor shaft and respective drive couplings interconnect a respective spool shaft to a respective motor shaft.

15. A tape drive according to claim 1 incorporated in a thermal transfer printer.

16. A tape drive according to claim 15, wherein the printer is configured to transfer ink from a printer ribbon to a substrate which is transported along a predetermined path adjacent to the printer, the tape drive acting as a printer ribbon drive mechanism for transporting ribbon between first and second ribbon spools, and the printer further comprising a printhead arranged to contact one side of the ribbon to press an opposite side of the ribbon into contact with a substrate on the predetermined path.

17. A tape drive according to claim 16, wherein the printer further comprises a printhead drive mechanism for transporting the printhead along a track extending generally parallel to the predetermined substrate transport path and for displacing the printhead into and out of contact with the ribbon, and a printer controller controlling the printer ribbon and printhead drive mechanisms.

18. A tape drive according to claim 17, wherein the printer controller is selectively programmable either to cause the ribbon to be transported relative to the predetermined substrate transport path with the printhead stationary and displaced into contact with the ribbon during printing, or to cause the printhead to be transported relative to the ribbon and the predetermined substrate transport path and to be displaced into contact with the ribbon during printing.

19. A tape drive according to claim 15, wherein the printer is a thermal transfer over printer.

20. A method of controlling a tape drive comprising two position-controlled motors, at least one of which is a closed-loop position-controlled motor, two tape spool supports on which spools of tape may be mounted, each spool being drivable by a respective one of said motors, and a controller for controlling the energization of the motors such that the tape may be transported in at least one direction between spools mounted on the spool supports, wherein the controller energises both motors to drive the spools of tape in the direction of tape transport, monitors tension in a tape being transported between spools mounted on the spool supports and controls the motors to maintain the monitored tension between predetermined limits.
